(19) United States
(12) Patent Application Publication
(10) Pub. No.: US 2007/0042625 A1
(43) Pub. Date: Feb. 22, 2007

(54) Busbar system

(76) Inventors: Reinhard Otto, Hainburg (AT); Hansjorg Hauer, Wien (AT)

Correspondence Address: DYKEMA GOSSETT PLLC, FRANKLIN SQUARE, THIRD FLOOR WEST, 1300 I STREET, NW, WASHINGTON, DC, 20005, US

(21) Appl. No.: 10/570,756

(22) PCT Filed: Sep. 9, 2003
(86) PCT No.: PCT/AT03/00264

§ 371 Date: Sep. 22, 2006

(51) Int. Cl. H01R 4/60

(52) U.S. Cl. 439/212

(57) ABSTRACT

A busbar element for electrical installations, particularly placed in buildings or the like or for incorporation in wall elements of buildings or the like, consisting of a substantially U-shaped profiled section (1) whose lateral limbs (2) are optionally provided with fixing devices for a cover (5) for said busbar (S) element, optionally comprising a retaining profiled section which can be attached on the rear side thereof with an additional U-shaped profiled (K) section, also comprising connecting chambers, connecting recesses and/or connecting ribs for connection to busbar elements or intermediate parts.

A system with of a plurality of electric circuits which can be rapidly and simply installed with space requirements as low as possible and with a minimal effort, which can be adapted and changed to the changing requirements of the user relative to output adapters and/or functional adapters whereby said system is provided with as least one active conductor (14) on at least one of the inner sides of the profiled section (1) and optionally a ground connector (14a) extending in longitudinal direction of said U-shaped profiled section (1) and whereby a retaining profiled section (16) extends in longitudinal direction on the inner side of said U-shaped profiled section.

At least one pair of active conductors (14) extends along both sides of the retaining profiled section (16) since special the focus is to be on the secure attachment of additional components.

The invention relates to a busbar element for electrical installations, particularly placed in buildings or the like or for incorporation in wall elements of buildings or the like, consisting of a substantially U-shaped profiled section whose lateral limbs are optionally provided with fixing devices for a cover for said busbar element, optionally comprising a retaining profiled section which can be attached on the rear side thereof with an additional U-shaped profiled section, also comprising connecting chambers, connecting recesses and/or connecting ribs for connection to busbar elements or intermediate parts, whereby as least one active conductor on at least one of the inner sides of the profiled section and optionally a ground connector are extending in longitudinal direction of said U-shaped profiled section, and comprising a connecting unit, a cover plate, a functional unit and a locking unit for the busbar elements.

Electric lines have been fixedly installed heretofore in living areas, offices, commercial buildings or the like and electric outlets have been place at predetermined locations in set directions. The use of extension cables, terminal boxes or the like is necessary to operate electric appliances at any desired location, which is optically not very appealing in a way and may also be dangerous since one may trip over loose cables lying about, the plug-in connection may be disconnected unintentionally, or electric appliances may be toppled over or pulled down. Often times, it may also occur that angled plugs have to be used in unfavorable positions whereby loops of cable are formed or whereby the arrangement of several plugs disposed closely next to each other is no longer possible.

Cable ducts or cable channels are known in which individual cables may run together and whereby, however, the outlets are also provided at predetermined locations and cannot be arranged and easily removed according to the changing requirements of the user. In contrast, DE 36 32 414 discloses an electric power supply rail whereby two electric conductors and a ground protection line are arranged, among other things, at the bottom of a support element having an essentially U-shaped cross section. It is described therein to arrange the ground protection lines between the electric conductors. However, undesired deformation of the side limbs of the support profile may lead in a disadvantageous manner to loosening or even detachment of additional components attached to the ends of the side limbs. These disadvantages also exist in the construction according to U.S. Pat. No. 5,759,051 in which a female plug is clamped onto a busbar at any desired position by rotating said female plug about an axis lying perpendicular to the busbar whereby two fastening clips engage the busbar with lateral retaining grooves and said retaining grooves can be considerably changed in their relative position and distance through minimal twisting or deformation of the busbar whereby the retaining function can be greatly impaired. However, two contact lugs engage at the same time two conductor rails through turning of the female plug whereby said conductor rails are arranged on the upper side leading through lateral grooves of the busbar. It therefore not possible to attach the female plug on the busbar in any orientation other than the one that is predefined.

In EP 0 159 078, a female plug is also attached as a supplement component to the outer ends of the lateral legs of the profiled section of the support of the busbar having its conductors essentially at the bottom of the profiled section of the support. This construction has also the disadvantage described above in that the additional component can become loose or it becomes disengaged altogether at deformation of the lateral legs.

U.S. Pat. No. 3,337,697 has as its object a conductor rail for trolley busways for which there are completely different prerequisites than the ones for the aforementioned busbars for living areas or the like. Besides, this conductor rail is resigned to cooperate with a movable electric power take-off and has only in common the arrangement of conductors at the bottom of the open profiled section of the support.

A conductor rail system is described in WO 00/60706 wherein an open retaining profile extends parallel to the side limbs at the bottom of the profiled section forming the conductor rail element whereby the side component of the support profile protrude from the bottom of the profile and they are provided with salient rails that are oriented toward the other side of the component respectively. Electric current can be drawn in a known manner at any point along the conductor rail element without having to install or fit cables. By changing the length of the conductor rail or by placing several such elements next to one another, there can be created the possibility around the entire room to provide an electric connection at any desired point, to change position, or to remove the connection. The conductor rail is thereby preferably covered between the electrical outlet connections to avoid soiling and to prevent any danger to life in the living areas. The embodiment according to the invention comprising a retaining profiled section on the bottom of the conductor rail element allows thereby, along any desired point along the length of the conductor rail element, the secure attachment of additional components such as electric female plugs or the like whereby possible deformation of the remaining parts of said element, especially its side limbs, does avoid as much possible loosening or even detachment of said female plugs from the conductor rail and whereby it does not or not noticeably hinder the installation of said supplemental components. If several separately powered electrical circuits are desired, only constructions can be designed with this known system in which conductor rails are running adjacent to one another requiring more space and higher costs.

It was therefore the object of the invention to provide a system for the supply of electric power by means of a plurality of electric circuits in living areas or the like which can be rapidly installed with space requirements as low as possible and with minimal effort and which can be adapted and changed to the changing requirements of the user relative to output adapters and/or functional adapters whereby in this case the focus is to be on the secure attachment of additional components.

For achievement of the object, the busbar element described in the beginning is characterized in that at least one pair of active conductors extend at both sides of the retaining profiled section. Not only can several users be supplied through separate electric circuits so that different parameters can be selected in the supply of energy, but one or several pairs of conductors could also be used as functional conductors for sensors or actuating mechanisms. These sensors or actuating mechanisms can be combined with traditional consumers or equipment (electrical outlets, light switches etc.)

An open hollow-rail-type retaining profile may be provided according to a first embodiment of the busbar element.

Another advantageous embodiment of the busbar element is characterized in that a hammerhead-type retaining profile is provided along the inner side of the U-shaped profiled section.

Greater flexibility in the choice of material exists if, according to an additional inventive embodiment of the invention, at least a few pairs of active conductors run on or in sub-profile sections. The U-shaped profiled section could be manufactured of a metallic material that is mechanically very stable while the sub-profile section is made of electrically insulating material.

According to an additional characteristic of the invention, an especially secure fastening of additional components to the U-shaped profile of the busbar is made possible, even in case of twisting of the busbar element, if the retaining profiled section is arranged essentially on the bottom of the U-shaped profile, especially between the pairs of active conductors.

The busbar element according to one of the claims 1 through 5 is characterized in that the conducting track provided as a protective ground conductor runs in or on the retaining profiled section in longitudinal direction of the U-shaped profile. An advantage is thereby provided in that grounding of the installed additional component can be achieved in a simple manner while attaching the fastening element of the additional component.

The leakage distances for the electric current become very large between the conductors if it is proposed according to an advantageous embodiment of the invention that the conducting tracks of the active conductors are arranged along the bottom or the side of the U-shaped profiled section or along the flat or wedge-shaped ribs projecting from the bottom of the sub-profile section and extending in longitudinal direction of the U-profiled section whereby said conductors are arranged preferably on the side of said ribs. This has again the advantage that the elements of the invention can be cut quickly and easily into sections without any insulating work thereafter.

In an additional embodiment of the invention, the busbar element can be characterized in that several separate conducting tracks, preferably bus or data lines, project from the bottom or the sides of the U-shaped profiled section or they are arranged on the rib which are extending in longitudinal direction of the U-shaped profile and are projecting from the bottom of the sub-profile section. This variant is especially advantageous for functional conductors, especially data lines and IT lines, which can be placed on said rib.

It is advantageously proposed thereby that the conducting tracks on the rib are designed as flat lines or profiled lines which are made to cooperate with the electric female plugs having spring contacts/spring clamps or insulation displacement contacts.

According to a first embodiment of the busbar element, the conducting tracks can lie partially bare at first to make easier the attachment and the electrical connection of the functional units.

Otherwise, increased safety is achieved during handling if the conducting tracks are covered with an electrically insulating layer according to another embodiment of the invention.

Ribs can be provided extending in longitudinal direction of the U-shaped profiled section and projecting from bottom of said sub-profile section or lying between the conducting tracks projecting from the bottom or the sides of said U-shaped profile. Ensured is thereby an even better separation of the individual conducting tracks as well as more safety against unintentional touching. The system can be expanded in a simple manner with additional cable ducts or the like or with supplemental elements if, according to an advantageous embodiment of the invention, a retaining profiled section is provided on the rear side of the U-shaped profiled section serving as a part of a hinge arrangement for an optional additional U-shaped profiled section.

The application possibilities of the busbar element can be expanded if additional cable ducts or functional ducts are formed on the sides of the U-shaped profiled section or are formed by means of ribs extending between the pairs of active conductors in longitudinal direction of said U-shaped profiled section.

An important element to achieve the objected stated in the beginning is also a connecting unit for the busbar elements described in the paragraphs above, which is characterized by at least two female track plugs interconnected by at least two flexible conductor sections whereby said track plugs make contact with at least one conducting track of one of the respective bordering busbar elements.

According to an additional characteristic of the invention, said connecting unit is advantageously characterized in that the female track plug consists of a module link having plug-in contact elements with associated contact retainers for the conducting tracks whereby the contact elements on the side of the track plug facing the conducting track of the busbar element are projecting in such a manner past the module link as well as past the contact retainer, which are essentially flush with the frame, so that said contact elements contact the conducting track when the track plug is inserted. This embodiment allows great flexibility in the arrangement of electric circuits or functional conductors with a minimal amount of components.

According to a first embodiment it is thereby proposed that the contact elements with their associated contact retainers are provided in pairs for the functional conductor pairs as a duplex module.

Alternatively, the contact elements for the protective ground conductor together with their associated contact retainers can be made as a single module.

The connecting unit of the invention is advantageously designed in such a manner that fixedly arranged conducting parts are provided parallel to the conducting tracks of the busbar elements in a contacting part facing away from the side of the track plugs on the conducting tracks of said busbar elements whereby said conducting parts make contact, on the one hand, with the contact elements, and with the flexible conductor sections, on the other hand.

Especially good contact with the conducting tracks of the busbar element is made possible if the contact elements are designed as bridges with contacting spring blades molded to both sides of said bridge whereby said spring blades are provided with straight or angled transition pieces which press against the intermediate ribs of the busbar element in the plugged-in position of the track plug or whereby said spring blades are designed as insulation displacement contacts.

According to an advantageous embodiment, the connecting unit of the invention is also characterized in that it consists of a plug strip with integrated in-line connectors.

It is especially advantageous to achieve simple and secure contact on the conducting tracks attached to the ribs whereby contact elements are provided for the conductors in the form of coaxial tube-shaped or hollow-shaped, thin double-sided insulating displacement contacts having axis-parallel contact pieces angled toward the inside in form of blades.

Another embodiment has similar advantages whereby contact elements are provided in the form of coaxial tube-shaped or hollow-shaped, thin, double-sided, spring-loaded clamping connection pieces with contact spring blades oriented toward the inside.

The busbar elements described above can be connected to one another at any angle if a connecting unit is provided having mounting pieces for the ends of the busbar elements which engage at least in semi-circular guide paths an upper and lower guide disks, which are spaced apart, and whereby the flexible conducting sections are guided through the free space between said guide disks.

In such a special connecting unit it is especially advantageous for protection of the electric connecting lines and for an aesthetic design if one or several blades can be inserted into the guides of the guide disk in the area of the free space between the mounting pieces and the busbar elements.

A cover plate for busbar elements of the system in the invention is characterized in that profiled sections are arranged extending on the inner side of the U-shaped profiled section in longitudinal direction to receive butt joint facings.

On the lateral edges can be advantageously be provided tapered sections and/or snap-on profiles and/or snap-on hooks which engage specially designed longitudinal profiles in the busbar elements, preferably under formation of a gap between the cover plate and the busbar elements on at least one longitudinal side.

Said butt joint facing for the abovementioned cover plate is advantageously characterized in that longitudinal ribs are provided in one profiled section supported by the U-shaped profiled section or the sub-profile sections whereby snap-on longitudinal ribs are provided in the receiving parts of the cover plate.

In cooperation with the abovementioned busbar elements and in view of the achievement of the aforementioned object there are functional units provided which are characterized in the invention through at least one adapter plate for the optionally detachable receiving parts of conventional functional inserts, such as, for example, female plugs, switch elements, outgoing cables, sensor elements, indicator or display elements, as well as a track plug and a locking element. Any desired connection and other electric components, such as operational elements etc., can be integrated into the system in a basic element which establishes the connection to the electric circuits or the functional conductors.

The functional unit is advantageously provided with a track plug designed as described above whereby the flexible conductor sections are connected to the contacts of the functional insert.

In another possible embodiment it could be proposed that rigid conducting tracks connect the contact elements of the track plug with the contacts of the functional insert in place of flexible conductors.

An especially advantageous embodiments is characterized in that fixedly arranged conductor sections are provided in the track plug on the side facing away from the conducting tracks of the busbar elements for all electric circuits whereby said conductor sections are oriented parallel to the conducting track of the busbar element and whereby said conductor sections make contact with the contact elements in the selected electric circuit, on the one hand, and whereby said conductor sections are connected to one another through series switching or parallel switching in the way of the conducting track, on the other hand, and whereby the conductor sections are connected to the functional inserts and to the contact elements.

Especially simple is the attachment of the functional unit on the U-shaped profiled section of the busbar in one embodiment wherein at least one boring is provided in the adapter plate and optionally also in the functional insert whereby said boring extends through the adapter plate, optionally through the functional insert, and normally through the bottom or the front side of the retaining profiled section of the busbar element and exactly above said retaining profiled section.

An advantageous rotatable functional unit makes possible this adjustment in orientation of the actual functional electric component, which means the female plug, the line connector, or the like, in that at least one conducting surface is provided on the adapter plate on the side facing the functional insert, whereby said conducting surface is bow-shaped about a center axis and extends at least along a quarter of a circle about this center axis, whereby the rear side of the functional insert facing the adapter plate is provided with at least one respective contact surface per contact surface of the adapter plate.

The above-described functional unit has advantageously also the characteristic that the front side of the adapter plate is provided with a receiving part for conventional plugs or other functional inserts and part of a guide structure is provided on the side of the adapter plate having contact surfaces, which is preferably a closed circular structure, and whereby the counter piece of the guide structure of the adapter plate is provided on the side of the functional unit facing said adapter plate.

In the functional unit described in the two paragraphs above there is an additional embodiment characterized advantageously in that a boring leading to the retaining profiled section extends through the adapter plate and the functioning unit whose center coincides with the center axis of the contact surfaces and the guide structures. Secure attachment to the U-shaped profiled section is thereby guaranteed in view of the achievement of the object stated in the beginning.

The mounting of additional components on the U-shaped profiled section is achieved according to the aforementioned object with the use of a locking element to be inserted into the boring of the adapter plate, or optionally into the functional insert, whereby said locking element is characterized according to the invention by a retaining structure which cooperates with the retaining profiled section and which can be inserted into said retaining profiled section or encompasses its end section.

According to a first advantageous embodiment, the locking element is characterized in the invention by two central symmetrically arranged snap-on wedges on two parallel spring-loaded lugs preventing twisting whereby said snap-on wedges engage the lateral strips of the retaining profiled section of the busbar element or encompass the head of the retaining profiled section.

The snap-on wedges are preferably designed in said locking element to be at a distance apart from the upper end and the lower end of the lugs which prevent twisting.

Another embodiment of the locking element is characterized by having at its end a radially widened head at two opposing sides which can be inserted into the retaining profiled section.

Fixing of the locking element and all additional components fixed thereby on the busbar can be achieved once more according to another embodiment whereby spreadable side pieces are provided on the end of said locking element which can be inserted into the retaining profiled section whereby said side pieces engage the retaining profiled section in the spread position or whereby they create a friction contact with the side wall of the retaining profiled section.

The spreadable side pieces in this embodiment of the locking element are elastically biased toward the outside about an axis that is normally oriented along the longitudinal axis of the locking element, and there is provided an actuation element which can be inserted into the end of the retaining profiled section which is movable in its longitudinal direction whereby said actuation element has lateral extensions of constant length which engage the side pieces at least partially.

Since the busbar element of the invention has additionally much free space to receive the electric conducting tracks or they can be designed for this purpose, said free space can be used as a cable channel as well whereby data cables, telephone cables, TV cables or other desired cables can be run through the busbar. To make the feeding of additional cables easier, it is proposed according to an additional characteristic of the invention that the busbar element or a profiled section receiving said element is provided with a guiding profiled section for a cable feeding device.

According to an additional characteristic, the cable feeding device comprises a slide that can be inserted into the guide profile and moved by sliding in longitudinal direction therein having a clamping device for at least one cable whereby said slide is attached or can be attached on a feeder band. Feeding of additional cables into the busbar is made easier thereby and it can be accomplished more rapidly.

The feeder band is thereby advantageously designed in the form of a toothed belt whereby a powered driving pulley designed complimentary thereto can be brought into contact with the feeder band at least periodically.

Feeding of additional cables can be performed at any point of the busbar element if the driving pulley is fastened to a frame which can be periodically coupled to the profiled section receiving the busbar element or to the frame that can be coupled to the busbar element, whereby the driving pulley can be preferably coupled detachably to an external driving device.

The invention is to be explained in the following description in more detail with the aid of accompanying drawings of preferred embodiment examples.

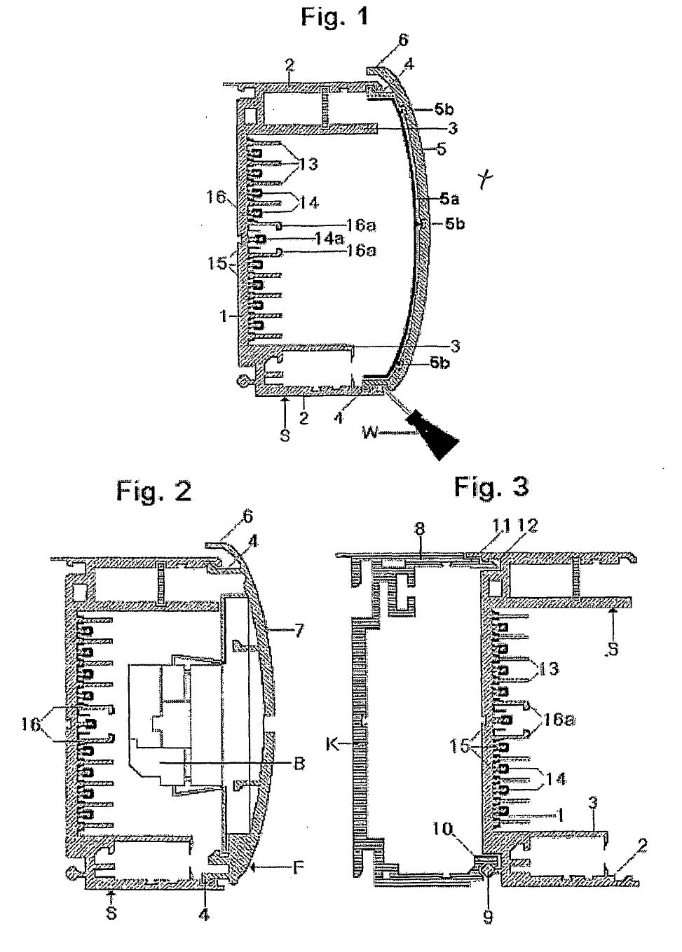

FIG. 1 shows thereby in a cross sectional view a busbar element together with a cover of a first embodiment;

FIG. 2 shows the busbar element of FIG. 1 with a mounted functional unit;

FIG. 3 is a cross section through the busbar element of FIG. 1 with an additional cable duct installed to the rear;

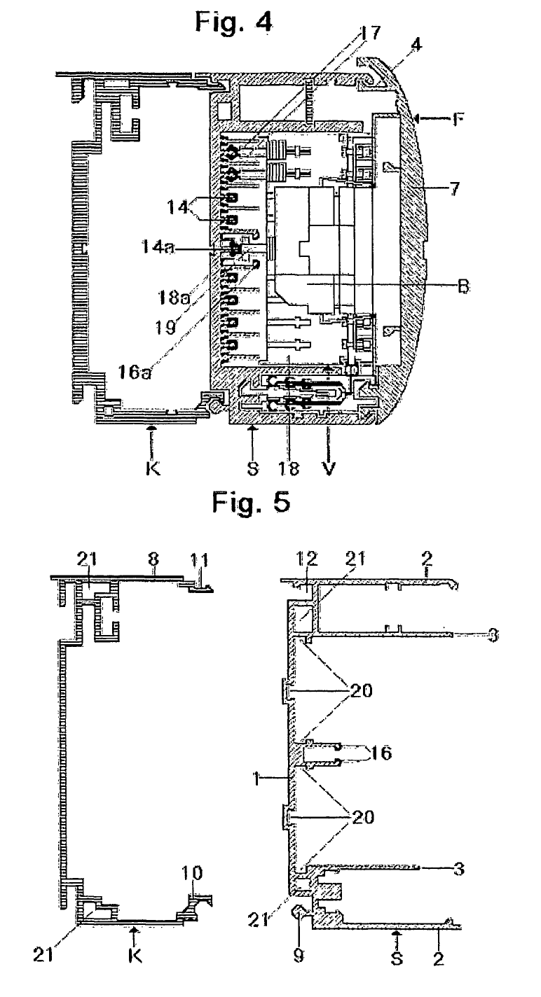

FIG. 4 shows the busbar element with a cable duct of FIG. 3 with a mounted and contacting functional unit;

FIG. 5 is and illustration of a busbar element of another embodiment together with an additional profiled section to be installed, e.g. a cable duct;

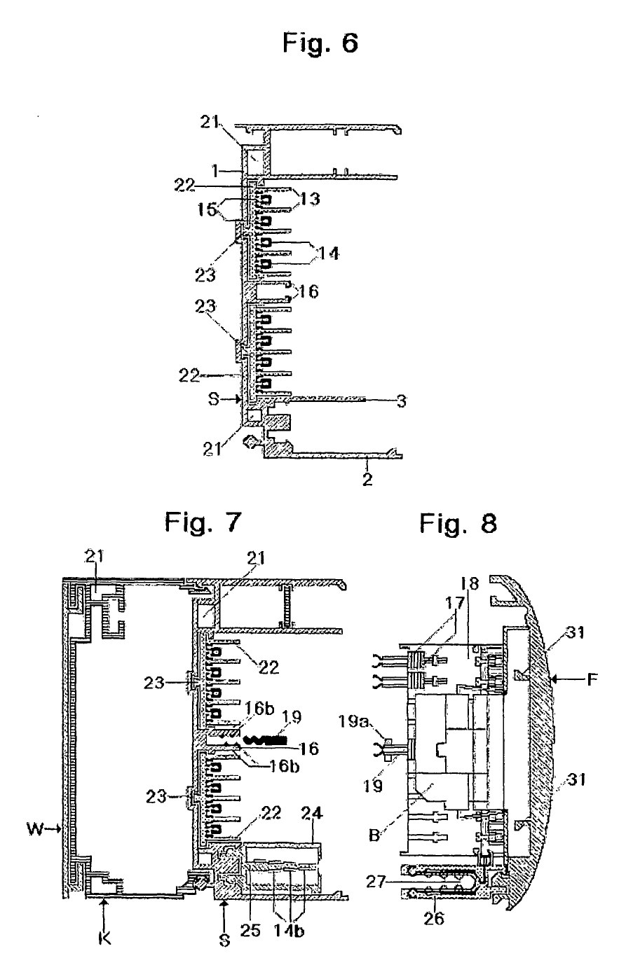

FIG. 6 shows the busbar element of FIG. 5 with inserted sub-profile sections for the electric conductors and the functional conductors;

FIG. 7 shows the busbar element of FIG. 6 with an added cable duct and a profiled section for mounting as well as additional conducting track on a rib in cross section;

FIG. 8 is a cross-sectional illustration of a functional unit to cooperate with the busbar element of FIG. 7;

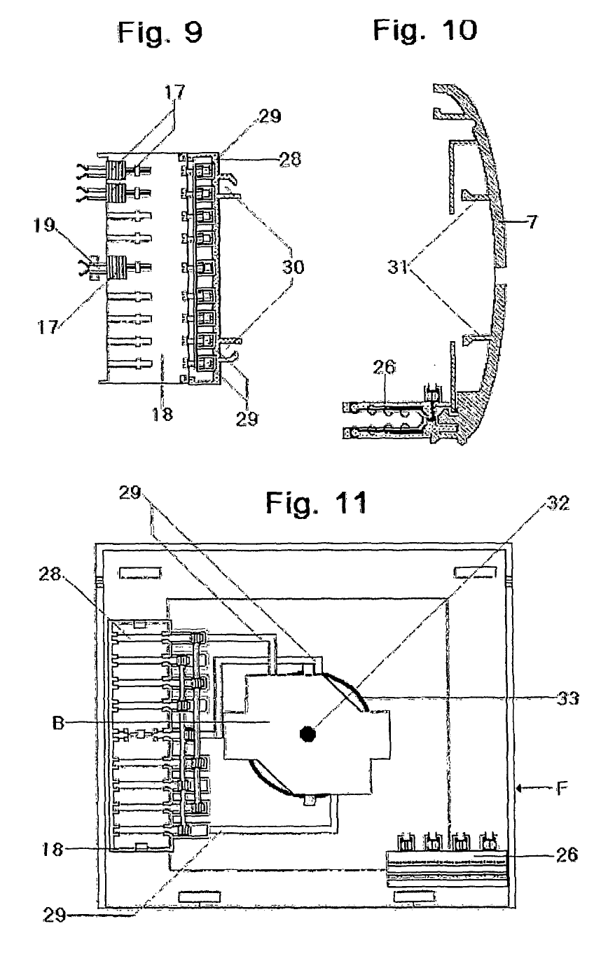

FIG. 9 shows a busbar element of FIG. 7;

FIG. 9 shows a female track plug for a functional unit of FIG. 8;

FIG. 10 shows a cover for the busbar element of FIG. 5 or FIG. 7 with set contact elements for the additional conducting tracks on the rib of FIG. 7;

FIG. 11 is a top view onto a functional unit having contact elements for the busbar element;

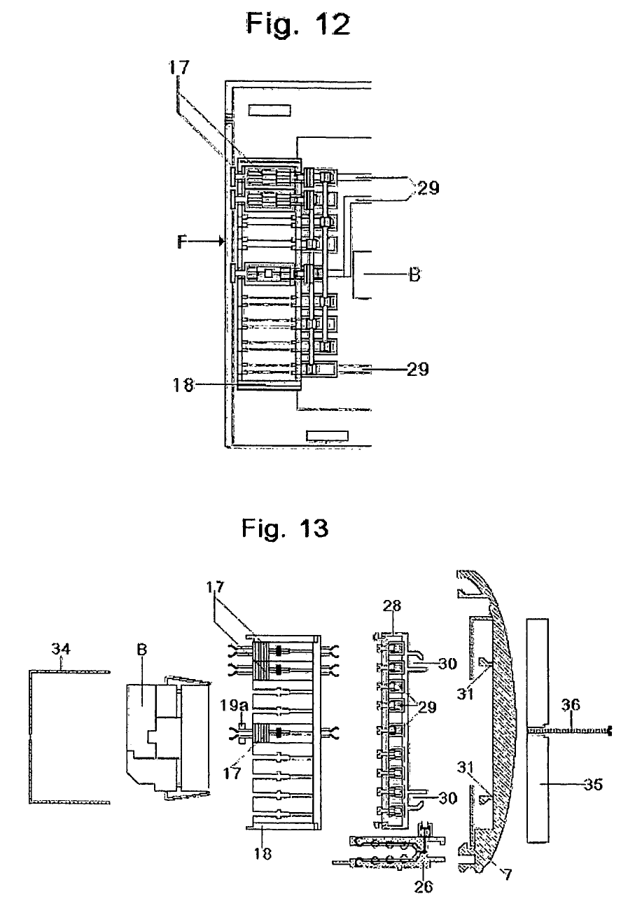

FIG. 12 shows a view of said contact element of FIG. 11 with inserted contact bridges;

FIG. 13 is an exploded view of the parts of a functional unit in cross section as it is illustrated in FIG. 4 or in FIG. 8 in an assembled condition or in a condition connected to the busbar element;

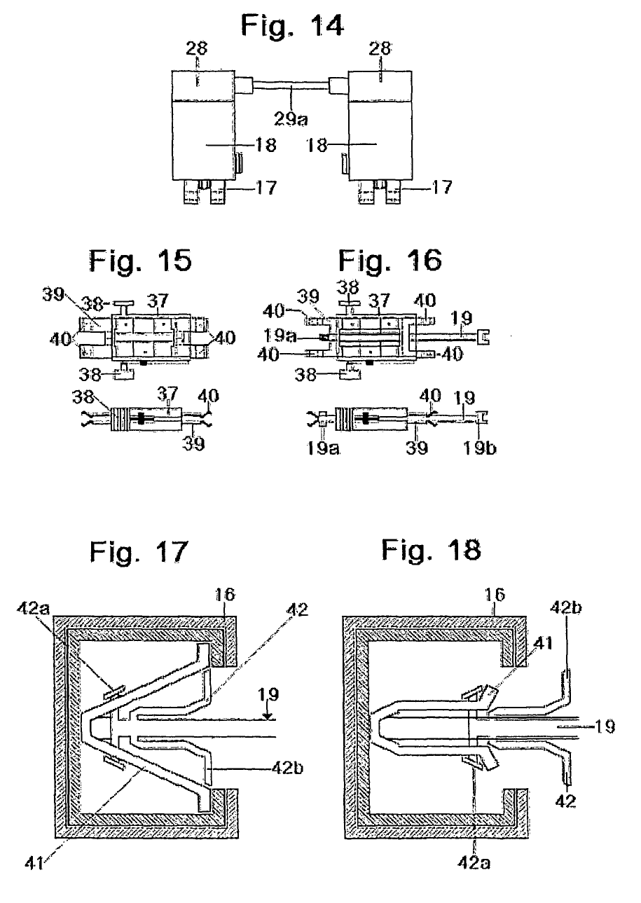

FIG. 14 is a side view of two connecting units connected by means of cables;

FIG. 15 shows a plug-in module of a first embodiment in both side views;

FIG. 16 is an illustration of a plug-in module together with a locking unit in the same side view as in FIG. 15;

FIG. 17 is a schematic illustration of a variant for the front end of the locking elements in a locked condition cooperating with the busbar element;

FIG. 18 shows the front end of the locking element in an unlocked condition;

FIG. 19 shows the locking element of FIG. 17 and FIG. 18 in a condition connected to the busbar element;

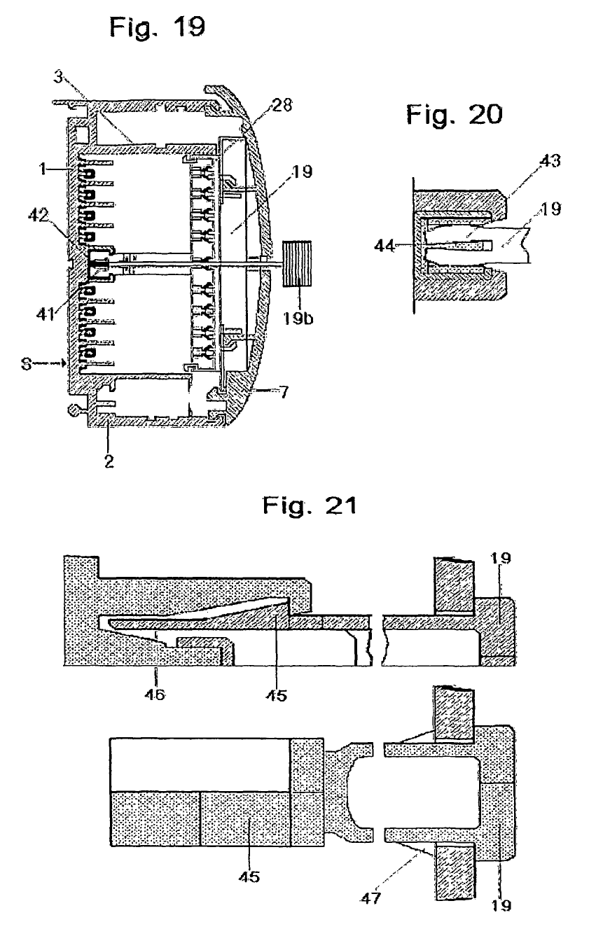

FIG. 20 is an illustration of an additional embodiment of the front end of the locking element cooperating with the busbar element;

FIG. 21 is again another embodiment of the front end of the locking element cooperating with the busbar element in both side views;

FIG. 22 shows a top view onto a corner joint of two busbar elements meeting one another;

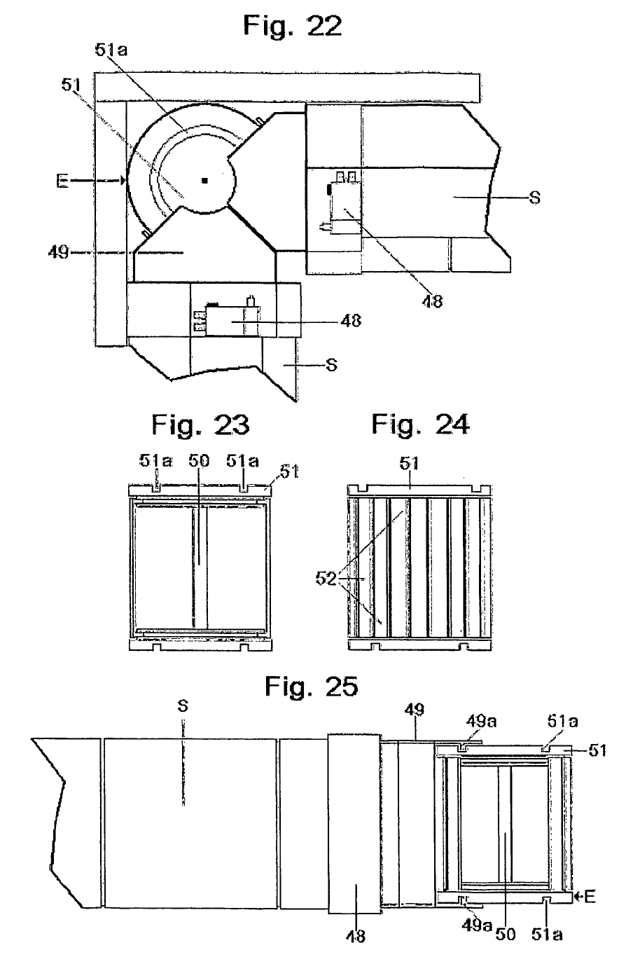

FIG. 23 is a side view of the connecting unit from FIG. 22;

FIG. 24 shows the connecting unit of FIG. 23 with inserted cover blades;

FIG. 25 shows one end of a busbar element with an adapter piece engaging the connecting unit of FIG. 23 and FIG. 24 in a side view;

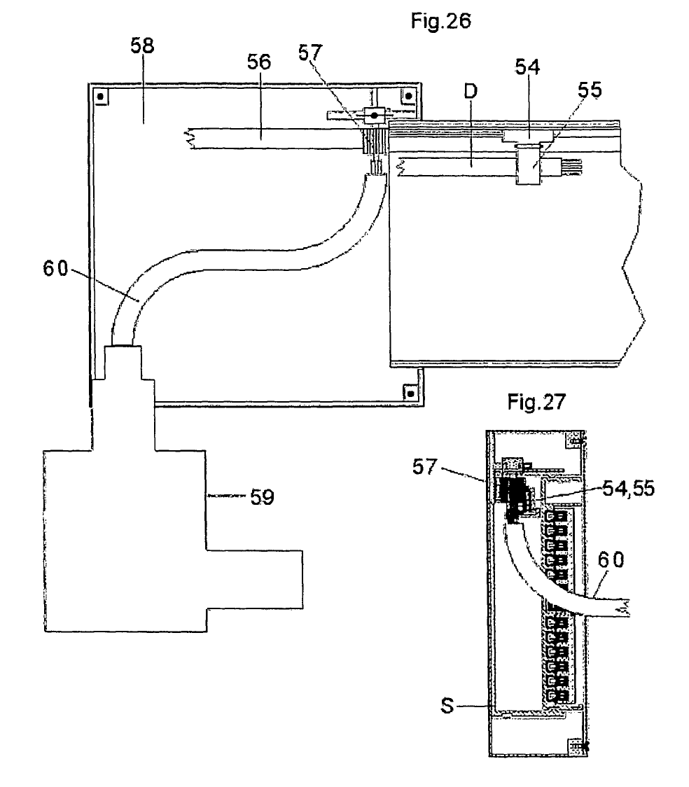

FIG. 26 is a view of a busbar of the invention with a cable feeding device;

FIG. 27 shows said cable feeding device in a cross section;

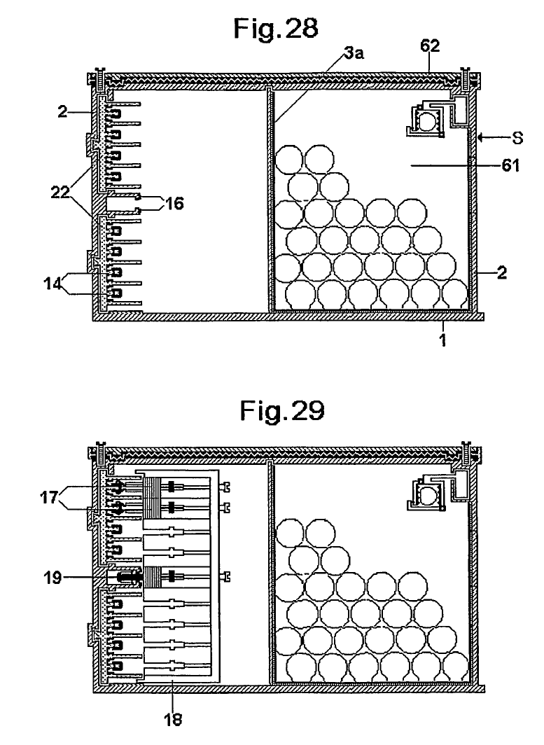

FIG. 28 is a view of a busbar element for floor installation with conducting tracks on one of the side walls of the profiled section;

FIG. 29 shows the busbar element of FIG. 28 with a mounted module link;

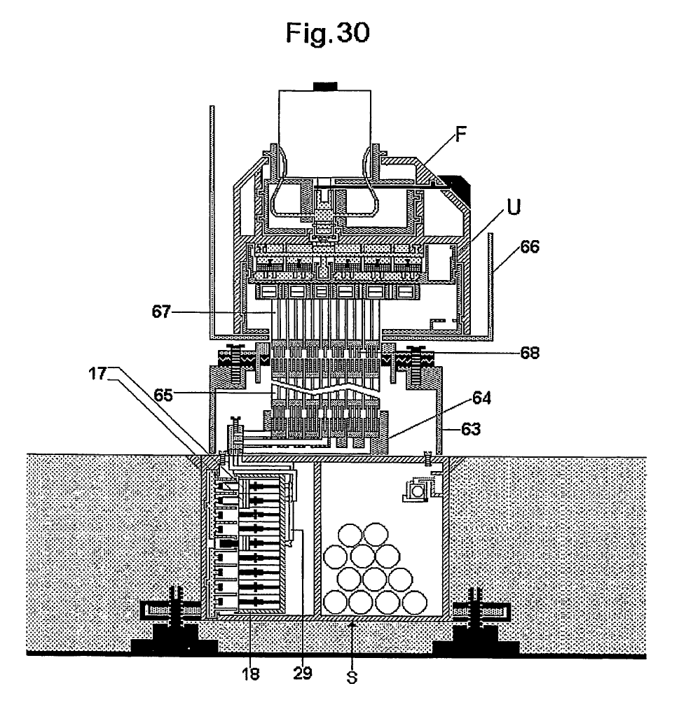

FIG. 30 is an illustration of a busbar element for floor installation with a transition adapter and an adapter for at least one conventional plugs, preferably several plugs;

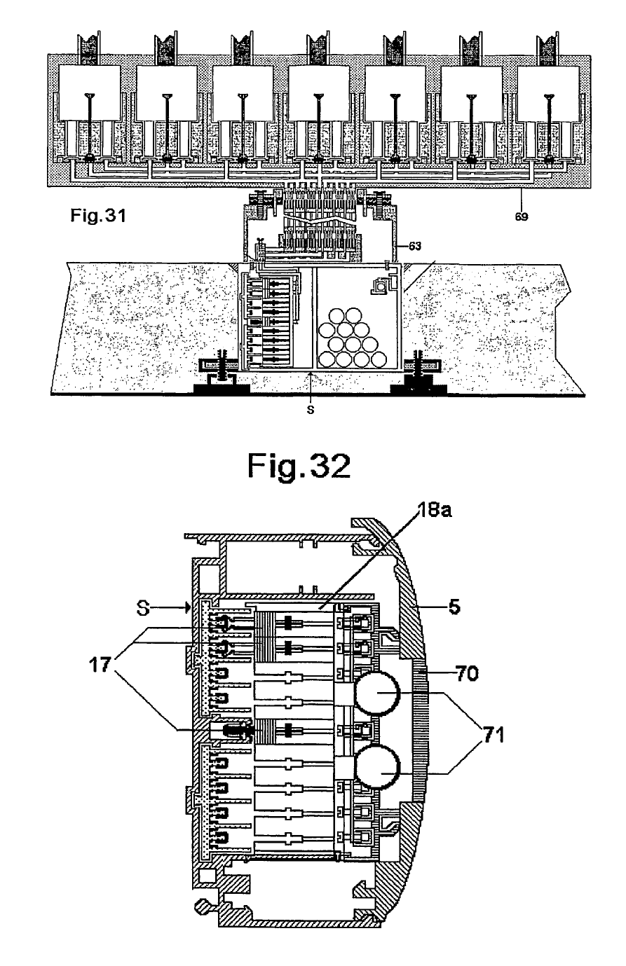

FIG. 31 shows a floor track with a somewhat differently designed transition adapter and plug adapter; and

FIG. 32 shows a busbar element with electric consumer in the form of lighting for emergency egress markings.

The busbar element S in a first embodiment illustrated in FIG. 1 consists of a substantially U-shaped profiled section, preferably with lateral limbs 2 connecting to a flat bottom 1 at a right angle. The bottom 1 could advantageously be extended toward the outside at both sides by means of installation lugs for the installation on walls, plaster walls or the like whereby said installation lugs may be provided at specific distances with borings, slots, predetermined breaking points or the like through which the busbar element S can be mounted on the wall by means of a screw and anchor arrangement, for example. The profiled section 1, 2 is preferably made of a synthetic material having good insulating characteristics and has possibly a coating to shield against electric smog. Additional limbs 3 can be provided leading from the bottom 1 of the profiled section parallel and within the lateral limbs 2 in or on said lateral limbs 2 and there could be receiving parts for the additional components or they could be the receiving part themselves to provide secure fastening of said components to be mounted independent from possible deformation of the lateral limbs 2 and not restrict the attachment or the removal of said additional components. For example, the space between the lateral limbs 2 and the additional limbs 3 can also be used as a cable channel for TV lines, data lines, telephone lines or the like. The system contains of course among other things feeding units made of conventional plugs or connectors for electric cables, longitudinal and corner connectors, knee-shaped connectors and end pieces.

The profiled section 5 can be fixed to the busbar S through elastic strips 4 of a profiled cover 5. Said cover 5 can be designed, for example, having predetermined breaking points or sections arranged next to the each other to be fitted at any desired length between the predetermined installation points for additional components or to create openings on these points for said additional components through which the additional components engage the busbar S and/or to be attached to the same. The profiled cover 5, which can be easily removed with the aid of a tool W, for example, could cover the entire height of the busbar S with its lateral limbs 6 or only a part thereof—during complete or partial installation behind mortar.

A plurality of electric conducting tracks 14 extend preferably between the additional limbs 3 and they extend in longitudinal direction of the U-shaped profiled section 1, 2, preferably between additional ribs 13. Said conducting tracks may run along the bottom of the U-shaped profile section 1,2; however, they are provided preferably at the upper end of the ribs 15 projecting from said bottom 1 of the U-shaped profiled section 1, 2. Neighboring conducting tracks 14 form preferably associated phase/neutral conductor pairs, but functional conductors can be realized thereby as well.

A conductor track 14a is also provided as a protective conductor and/or ground conductor, preferably centrally on the bottom 1 or on a central rib 15 of the busbar S. Said conductor track 14a can advantageously be arranged within the retaining profiled section 16, which also serves to attach and fix components on the busbar 5 at any desired point in a rapid and simple manner. The retaining profiled section 16 is formed by two central ribs, for example, on which widened strips 16a are provided at the upper end section thereof and which are oriented respectively toward the other rib. Of course, the conductor track for the ground could also run outside the retaining profiled section 16, in principle. The conductor track 14, 14a could extend in a bare manner at least partially but preferably along the entire length of the busbar element S so that electric contact can be established during the connection with an additional component in the most simple and rapid way. Otherwise, possible sheathing of the conductor tracks 14, 14a with electrically insulating material increases safety—extending additionally to the ribs 13.

In an embodiment of the cover 5 of the busbar 5 made of metallic material, e.g. aluminum, no overlapping joints exist based on the continuous construction thereof. Proposed is a butt joint facing 5a made of synthetic material to save on the expensive and complicated processing through milling whereby said facing is very thin and flexible and it is fixed on the inner side of the cover 5 on the side facing the profiled section 1, 2 by means of a snap-on connection, for example. The profile of the butt joint facing 5a is provided therefore with possible longitudinal ribs placed on the busbar 5 and snap-on longitudinal ribs 5b in the receiving part of the cover plate 5.

A functional unit F is attached to the busbar element S in FIG. 2 in the same manner as the profiled cover 5 of FIG. 1 whereby said functional unit comprises a conventional electric component B, e.g. a plug, an operational unit, a light or the like, which can be attached under a cover plate 7, for example, and whereby said cover plate 7 is provided with the same elastic strips 4 as the profiled cover 5. The profiled cover 5 as well as the functional insert F can be folded back from the busbar element S by means of a loose hinge formed by the lower elastic strip 4 and its receiving part in the lower lateral limb 2.

Another separate additional profiled section K can be seen in FIG. 3 attached to the lower rear side of the busbar S whereby said additional profiled section K can form an additional cable channel. Said profiled section K is fastened on one side (the lower side in FIG. 3) to a loose hinge on the rear side of the U-shaped profiled section 1, 2 and it can be folded away across the top whereby said loose hinge is formed by a rib or a discrete stud 9 having a widened upper edge or head on the busbar S and a complimentary shaped rib 10 on the lateral limb 8. A type of a snap-on connection is formed between a rib or some discrete studs 11 on the side limbs 8 of the profiled section K and a receiving part with an undercut section on the rear side of the busbar element S.

Even though the busbar element S, the additional profiled section K, the profiled cover 5 etc. can be cut to size at any desired length, it is of advantage for the cost-effective production and storage to have the design in predetermined lengths, e.g. in lengths of 1 meter, 2 meters and 4 meters. Two neighboring busbar elements can be kept in a spatial constant position to one another during installation; however, it is of advantage to have a connection through a system which includes at the same time the mechanical connection elements and the connection elements establishing the conductive coupling.

A busbar element S in FIG. 4, as already introduced in FIG. 1 and FIG. 3, is connected to an additional profiled section K on its rear side as well as to a functional unit F. The connecting unit V can also be seen in FIG. 4 which establishes the electrical connection between the conducting tracks 14, 14a in the busbar element S and the conventional component B in the functional unit F by means of contact inserts 17. Said contact inserts 17 project from one link 18—as it is explained in more detail below—and they grasp the conducting tracks 14, 14a with end pieces being a type of spring-loaded clamp or an insulation displacement connector.

In FIG. 4 there can finally also be seen the end of the locking element 19, which engages with hammerhead-shaped widened parts 18a the strips 16a of the retaining profiled section 16 and detachably fixes in this way the functional insert F by itself or in addition to the fastening mentioned above with the aid of the elastic strips 4 to the U-shaped profiled section 1, 2.

Another embodiment of a busbar element S and an additional profiled section K is illustrated in FIG. 5. The design in FIG. 5 is made of a metallic material, e.g. aluminum or an aluminum alloy, as an embodiment that is mechanically more stable. The bottom 1 of the busbar element S is designed to be essentially flat and is provided possibly only with retaining grooves 20 extending in longitudinal direction and the retaining profiled section 16 disposed essentially in the center. In the corner areas between the bottom 1 and the lateral limbs 2 of the busbar element S there are provided on its inner side retaining grooves 20 as well as connection chambers 21, closed-off against the inner side of the U-shaped profiled section 1, 2, for the insertion of two connection pieces (not illustrated) connecting abutting busbar elements S. Such connection chambers 21 are also provided in the profiled section K. The design is otherwise the same as in the already explained embodiments.

As it can be seen in FIG. 6, sub-profile sections 22 are held in the retaining grooves 20 by means of strips provided on the bottom side thereof or by means of discretely distributed studs 23 whereby said retaining grooves can also be provided in the corner areas between the bottom 1 and the retaining profiled section 16. Said sub-profile sections 22 are made of an electrically insulating material, preferably PVC, and separating ribs 13 are formed on said sub-profile sections 22 or conductor tracks 14 are possibly disposed on said ribs 15 projecting from the sub-profile sections 21.

FIG. 7 shows the busbar S with the insulating sub-profile sections 22 inserted therein and assembled with the additional profiled section K for an additional cable channel or the like. It can also be seen that the retaining profiled section 16 can be provided not with only one strip widening toward the opposing respective limb, but it can have possibly several strips 16b lying on top of one another. Said strips 16b on the opposing limbs are preferably arranged in an offset manner at a height above the bottom of the retaining profiled section 16 so that an end piece of the locking element 18 can be screwed into said retaining profiled section.

Furthermore, an additional sub-profile section 24 is inserted into the busbar element S in the embodiment of FIG. 7, preferably by means of a snap-on connection, which is thereby detachable again. Separate conducting tracks 14b extend in said busbar element S, preferably as flat conductor lines or as wedge-shaped profiled lines as illustrated running on the rib 25 projecting from the bottom of the sub-profile section 24 in longitudinal direction of said sub-profile section 24 and thereby also in the longitudinal direction of the U-shaped profiled section 1, 2 of the busbar element S. Said conducting tracks 14b are mainly used for the bus systems extending along the busbar or for IT purposes.

A wall rail W is indicated by doted lines behind the additional profiled section K, which can be used for holding the busbar S with or without the additional profiled section K, so that no fastening elements for installation have to lead through the U-shaped profiled section 1, 2 and/or mechanically weaken the same through respective borings. Based on the location of the conducting tracks 14, 14a, the positions for the fastening devices of the busbar element S would be greatly limited while positioning of fastening devices independent of the design of the U-shaped profiled section 1, 2 ensures better flexibility.

As illustrated in FIG. 8, an especially shaped contact section 26 is fixed in the functional unit F to make contact with said additional conducting tracks 14b whereby said contacting profiled section 26 is connected by means of a snap-on connection or an otherwise detachable connection to the functional unit F. Electric contacts 27 are provided in said functional unit which are connected through any desired line passages to the link 18 or to other electric components in the functional unit F—the link 18 is separately illustrated in FIG. 9. The central contact insert 17 coincides for the most part with the locking element 19, as it can be clearly seen in FIG. 9, whereby said locking element preferably leads through said central contact insert 17 and the link 18. Said central contact insert 17 is in fact designed to make contact with the ground conductors running mostly in the central retaining profiled section 16. A contact piece 28 is preferably detachably fixed on the link 18, preferably again by means of a detachable connection, whereby said contact piece 28 contains end pieces of the electric line 29 in the form of cables or in any other desired design and whereby said contact piece 28 makes a conductive connection with the end of the contact inserts 17 facing away from the busbar element S. The lines 29 can lead then in a rigid or flexible manner as a bridge between two bordering busbar elements S to another contact piece 28—or they can lead to any desired electric component B of a functional insert F. Fastening profiled sections 30 can also be seen on the rear side of the contact piece 28 whereby said fastening profiled sections 30 may be provided with complimentarily shaped strips or studs 31 on the functional insert F or on a profiled cover 7.

Such a profiled cover 7 is illustrated in FIG. 10 comprising a strip 31 designed for insertion into the fastening profiled section 30. The profiled cover of FIG. 10 is also illustrated in a condition connected to the contacting profiled section 26, which is to serve as an example that this contacting profiled section 26 can not only be connected to the link 18 or to the contact part 28, but it can also be detachably fastened alone on the profiled cover 7 independent from the other components. Contacting of the conducting tracks 14b is made possible thereby independent of the functional inserts F and on any desired other point along the busbar.

The front end of the locking element 19 facing the busbar element is provided in the embodiment of FIG. 8 with two hammerhead-shaped widened parts 19a and it is therefore not provided for the retaining profiled section 16 of FIG. 7 but for the simple retaining profiled sections having only one strip 16a.

FIG. 11 shows a top view onto a functional unit F having a conventional electric component B, such as a female plug or the like, while FIG. 12 shows a view of the side of the U-shaped profiled section 1, 2 of the busbar element S. The component B is either fixedly installed on the functional unit F or preferably detachably connected thereto, possibly through a snap-on connection, by means of screws or the like. The attachment of the component B to the functional unit can also be achieved with the retaining element 19, which fixes the entire functional unit f to the busbar S. In that case, a passage 32 is provided for the locking element 19 leading through the component B and also through the functional unit F and it continues to the preferably central retaining profiled section 16 of the busbar element S. Of course, said passage 32 coincides advantageously with the rotational axis of the component B during a twisting attachment of said component, which is symbolized in FIG. 11 by including guide structures 33 in the shape of circle segments

It also can be seen in FIG. 11 and in FIG. 12 that the link 18 for the contact inserts 17 does not have to be arranged directly underneath the component B whereby said contact inserts 17 can be inserted for the prepared receiving parts of the link 18. The illustrated arrangement of the link 18 on the side of the component B is realized advantageously to save on the height of construction as viewed, of course, in longitudinal direction of the U-shaped profiled section 1, 2. The lines 29 from the receiving parts of the contact inserts 17 may be separate conductive wires, applied by means of sputtering or conducting tracks or the like applied by any other process. As already explained in conjunction with FIG. 8, an especially shaped contacting section 26 can be fixed on the functional unit whereby said contacting section serves to make contact with the additional conducting tracks 14b.

FIG. 13 shows again in a preferred example the design of a functional unit F according to the invention. The electric component B is preferably a conventional inner part of a plug or an otherwise common electric or electronic component, possibly a sensor, an operational element or unit, a telephone adapter or a data cable adapter, a light fixture or more of the same. The rear side of the component B is protected preferably by means of a cover 34 against soiling or touching of the parts carrying electric current. The link 18 is disposed adjacent to the component B as viewed in longitudinal direction of the busbar element S whereby the contact inserts 17 are pushed into the link 18 at the respective points which lie above the conducting tracks 14, 14a of the busbar S to be contacted. To this end, the contact inserts 17 make contact with their one end with said conducting tracks 14, 14a and they make contact with the opposite end with the ends of the of the lines 29 in or on the contact piece 28, which preferably becomes located above the link 18. A detachable connection exists preferably between the link 18 and the contact piece 28.

Said contact piece 28 and the link 18 is preferably detachably fastened to a profiled cover 7 through mutual engagement of the strips in the fastening profiled sections 30 on the contact piece 28. An additional profiled contact section 26 for preferably data lines, bus lines, telecommunication lines or IT lines can be preferably fastened detachably to the profiled cover 7. The electric component or manufactured sections of the profiled cover 7 or the contact piece 28 can be covered and protected from the environment by means of a preferably mass-produced cover plate 35. Said cover plate 35 may be fixed by means of the screw 36 or with other fastening devises such as a snap-on connection. The screw 36 can fix at the same time the entire functional unit F to the busbar S in a corresponding design of the retaining profiled section 16 through engagement into said retaining profiled section as illustrated in FIG. 7. Another locking element 19, e.g. with a hammerhead-shaped end 19a, could be provided in place of said screw 36 to engage the simple retaining profiled section 16. Rigid profiled connecting sections could be used to conductively connect adjoining busbar elements S with one another whereby said connecting sections make also contact with the conducting tracks 14, 14a and which establish the electric conductive connection in addition to the mechanical connection. Very little free space is provided therefore for height or angled fitting of the joint abutment between two U-shaped profiled sections 1, 2. The flexible conductor bridge shown in FIG. 14 could be of advantage in specific cases in which the contact elements of the adjoining busbar elements S are interconnected via flexible conductive wires or cables 29a whereby the contact elements include the link 18 and the contact piece 28 connected thereto.

The two embodiments of contact inserts 17 of principally the same type are illustrated in FIG. 15 and FIG. 16 in two side views by being viewed differently by 90 degrees. FIG. 15 shows on top a side view of the wide side of a simple contact insert 17. In a sheathing 37 with attached handling pieces 38 there is held in place a metallic electric conductive element 39 in the form of an essentially flat but repeatedly rounded-off platelet to be fixed in the sheathing 37. This platelet 39 projecting past the sheathing 37 is provided on its two ends with two respective parallel elastic deformable contact lugs 40 with end pieces that are shaped concave toward the inside which engage and make electric contact at one side with the conductive tracks 14, 14a of the busbar element S and with the ends of the conductors 29, 29a in the contact piece 28. The locking element 19 is guided through the sheathing of the contact insert 17 shown in FIG. 16 in addition to the electric conductive element 29 whereby said locking element 19 leads in the center through the two contact lugs 40, which are designed smaller for this reason than in the embodiment of FIG. 15. In FIG. 16 can be seen the locking element 19 with its hammerhead-shaped head 19b engaging with its end the opposing retaining profiled section 16 whereby said head is provided with a groove, crossed slots or a depression for an Allen wrench to be actuated with a screwdriver, for example. A design for manual twisting only would be conceivable as well.

FIG. 17 through FIG. 19 show an additional embodiment of the front end of the locking element 19 engaging the retaining profiled section 16. Spreadable lateral limbs 41 are provided at the end of the locking element 19 which are elastically biased toward the outside and about an axis oriented normally to the longitudinal axis of the locking elements 19 whereby said lateral limbs are elastically biased preferably through the selection of a suitable material and the geometric arrangement. An actuation element 42 is provided opposite the insertable end of the retaining profiled section 16 whereby said actuation element 42 can be moved by sliding in the longitudinal direction of said retaining profiled section 16 and whereby said actuation element 42 is provided with lateral extensions 42a of constant length engaging the lateral pieces 41 at least partially. The extensions 42a can be guided advantageously in the slots of the spreadable side pieces 41. Radial blocking elements 42b can be provided on the actuation element 42 for secure fixing of the side pieces 41 in the fully spread-out position.

As it can be seen in FIG. 19, the locking element 19 can also be provided with a head 19b designed to be actuated manually with which all types of locking systems can be actuated, as for example the click lock shown in FIG. 17 and FIG. 18. Since the head 19b projects past the profiled cover 7, it is proposed according to an advantageous embodiment that the front end of the retaining element 19 is detachable and may preferably be again re-coupled, or that the head 19b is designed to be removable.

FIG. 20 shows another locking system. The front end of the locking element 19 is hereby characterized by an oval tubular section 43 which is inserted into the retaining profiled section 16 and which is provided with recesses at both sides at least in the area of the strips 16a or said retaining profiled section 16. The tubular section 43 stuck in the retaining profiled section 16 can be spread out by means of the locking element 19 so that it can no longer be pulled out of the retaining profiled section 16 and a positive fit is created thereby.

FIG. 21 shows another type of a locking system. The front end of the locking element 19 is hereby provided with two central symmetrically arranged snap-on wedges 45 which are arranged on two parallel spring-loaded lugs 46 which prevent twisting. Said snap-on wedges 45 engage the inwardly facing strips of the retaining profiled section of the busbar element S or they grasp the head of a retaining profiled section designed with a widened head on a rib. The snap-on wedges 45 are at a distance apart from the upper and also from the lower end of the twist-prevention lugs 46. A plurality of support wedges 47 may be provided in the retaining element of the locking element 19 of FIG. 21 to secure the position.

FIG. 22 through FIG. 25 illustrate by way of examples how a corner connection of two busbar elements S can be produced in a simple and aesthetic manner. Adapter pieces 48 are attached to the ends of adjoining busbar elements S from which flat mounting pieces 49 are projecting and which can be connected to a common corner connection element E in preferably any desired angle. Said corner connection element E is designed preferably in the form of a cylindrical body or in the form of two guide disks 51 kept at a distance apart by means of a central rod 50. Two at least semi-circular guide tracks, preferably guide grooves 51a, are provided in said guide disks 51 whereby studs or strips 49a of the mounting pieces engage said guide grooves 51a. The conducting tracks 14, 14a of the two busbar elements S are conductively interconnected through flexible bridges as illustrated in FIG. 14 whereby the preferably flexible conducting sections 29a lead through the corner connection element E and especially through the free space between the guide disks 51. One or more blades 52 or a single fitted cover can be inserted in the guides of the guide disks 51 to cover said free space.

The cable channel or the cable duct K formed additionally or within the busbar S has been often mentioned in the above description of the busbar system according to the invention. A part of the present invention is therefore also a device to make the feeding of these additional cables easier and quicker which is illustrated in FIG. 26 and FIG. 27. The basis for this device is an embodiment of the profiled section forming the busbar S with a guiding profiled section 53 (see FIG. 7) for a cable feeding device, which is described in more detail below. This cable feeding device comprises at least one slide 54 which can be inserted in said guiding profiled section 53 and which can be moved by sliding therein whereby said slide is provided with a clamping device 55 for at least one cable D. The inner side of said clamping device 55, which can be folded up about a hinge, or the like, to insert the cable, and it is advantageously provided with a coating or with a textured surface to prevent slipping of the cable D. The slide 54 is attached or attachable to a feeder band 56 which is advantageously designed in the form of a toothed belt. The thickness of the feeder band 56 and the dimensions of the guiding profiled section 53 are adjusted to one another in such a way that the feeder band 56 can normally not fold up at its length even when stressed by pushing so that it is pushed further through the guiding profiled section 53. This pushing effect is advantageously achieved by means of the complimentary texture on the feeder band 56 and with an advantageously powered driving pulley 57 whereby said driving pulley 57 can engage the feeder band 56 at least periodically. The driving pulley 57 is fastened to a frame 58 that can be coupled periodically with the profiled section of the busbar element S or with a profiled section receiving said element whereby the driving pulley 57 can be detachably coupled via a flexible shaft 60 to an external driving device, e.g. an electric motor, a drill 59 or the like.

Another embodiment of the busbar 5 according to the invention is illustrated in FIG. 28 in cross section. This embodiment is preferred for installation in the floor or on the ceiling. The recesses or ribs 14 for several electric conducting tracks, respective phase/neutral conductor pairs, as well as the retaining profiled section 16 preferably arranged between these conducting tracks 14, are provided on the side walls 2 instead of on the bottom of the profiled section 1. A cable duct 61 for additional data cables, TV cables, or similar cables is formed by an additional limb 3a and the limb 2 disposed opposite the conducting tracks 14. A flat cover 62, preferably with a sealing element in between, is now provided in place of a curved cover. Contact with the conducting tracks 14 is achieved in the same manner as described above and as shown in FIG. 29. The module link 18 with the contact inserts 17 is fixed again on the side wall 2 of the busbar element S by means of the through-going locking element 19 in the retaining profiled section 16. FIG. 30 shows a busbar S installed in a floor having a module link 18 which is fixed by the retaining element 19. A transition adapter 63 is fixed on the busbar whereby electric conductors 29 lead from the contact inserts 17 to the plug-in connections 64 in said adapter 63. Flexible conducting cables 64, which can be plugged into the plug-in connection 64, lead to the top of the transition adapter 63. A profiled section 66 is preferably rotatably placed in said transition adapter 63 whereby a module U can be disposed in said profiled section 66 for an expanding installation of the functional unit F whereby said module U is similar to the principal design of a busbar S as it was described in the beginning. The conducting tracks of said module U can be connected to the conducting cables 65 again preferably via flexible conducting cables 67 and the plug-in connections 68.

A somewhat different solution is shown in FIG. 31, in which, nevertheless, a transition adapter 63 of the same design as mentioned above is also mounted on the floor busbar S, whereby said transition adapter 63 is provided an essentially traditional plug strip 69 which is placed again rotatably on said transition adapter 63. The conducting cables in the plug strip 69 are thereby hard-wired.

However, the consuming device can also be arranged on the busbar S itself in place of only external consuming devices which are supplied with electric power through the busbar S and the functional inserts F, as illustrated in FIG. 32. For example, an indicator system for emergency egress ways can be realized if the cover 5 of the busbar S has a design in which are provided at least partially transparent areas 70. On a special module link 18a there are provided not only plug-in points for the contact inserts 17 but there are also electric light sources mounted, which can be supplied with electric power through the electric circuits of the busbar S. The electric conductive connection extends thereby not to the plug adapters or the like but directly to the electric consumer 71 on the module link 18a. Of course, the consumer(s) 71 can be connected to an additional emergency battery which can also be attached to the connecting part.

1. A busbar element for electrical installations, particularly placed in buildings or the like or for incorporation in wall elements of buildings or the like, consisting of a substantially U-shaped profiled section (1) whose lateral limbs (2) are optionally provided with fixing devices for a cover (5) for said busbar (S) element, optionally comprising a retaining profiled section which can be attached on the rear side thereof with an additional U-shaped profiled (K) section, also comprising connecting chambers, connecting recesses and/or connecting ribs for connection to busbar elements or intermediate parts, wherein at least one active conductor (14) on at least one of the inner sides of the profiled section (1) and optionally a ground connector (14a) extend in longitudinal direction of said U-shaped profiled section (1) and wherein a retaining profiled section (16) extends in longitudinal direction on the inner side of said U-shaped profiled section (1), at least one pair of active conductors (14) extending along both sides of said retaining profiled section (16).

2. A busbar element according to claim 1, wherein an open hollow-rail-type retaining profile (16) is provided.

3. A busbar element according to claim 1, wherein a hammerhead type retaining profile is provided along the inner side of the U-shaped profiled section (1).

4. A busbar element according to claim 1, wherein at least a few pairs of active conductors (14) run on or in sub profile sections (22) which can be inserted in corresponding receiving pieces (20) on the inner side of the U-shaped profiled section (1).

5. A busbar element according to claim 1, wherein the retaining profiled section (16) is arranged essentially on the bottom of the U-shaped profile (1).

6. A busbar element according to claim 1, wherein the conducting track provided as a protective ground conductor (14a) runs in or on the retaining profiled section (16) in longitudinal direction of the U-shaped profile (1).

7. A busbar element according to claim 1, wherein the conducting tracks of the active conductors (14, 14a) are arranged along the bottom or the side of the U-shaped profiled section (1) or along the flat or wedge-shaped ribs (15) projecting from the bottom of the sub profile section (22) and extending in longitudinal direction of the U profiled section whereby said conductors are arranged on the side of said ribs.

8. A busbar element according to claim 1, wherein several separate conducting tracks (14b) project from the bottom or the sides of the U-shaped profiled section (1) or they are arranged on the rib (25) which are extending in longitudinal direction of the U-shaped profile and are projecting from the bottom of the sub profile section (22).

9. A busbar element according to claim 8, wherein the conducting tracks (14b) on the rib (25) are designed as flat lines or profiled lines which are made to cooperate with the electric female plugs having spring contacts/spring clamps or insulation displacement contacts.

10. A busbar element according to claim 1, wherein the conducting tracks (14, 14a, 14b) lie at least partially bare.

11. A busbar element according to claim 1, wherein the conducting tracks (14, 14a, 14b) are covered with an electrically insulating layer.

12. A busbar element according to claim 1, wherein ribs (13) are provided extending in longitudinal direction of the U-shaped profiled (1) section and projecting from bottom of said sub profile section (22) or lying between the conducting tracks (14, 14a) projecting from the bottom or the sides of said U-shaped profile (1).

13. A busbar element according to claim 1, wherein a retaining profiled section (9) is provided on the rear side of the U-shaped profiled (1) section serving as a part of a hinge arrangement (9, 10) for an optional additional U-shaped profiled section (K).

14. A busbar element according to claim 1, wherein additional cable ducts or functional ducts are formed on the sides of the U-shaped profiled section or are formed by means of dividing ribs (3) extending between the pairs of active conductors in longitudinal direction of said U-shaped profiled section.

15. A connecting unit for busbar elements according to claim 1, wherein at least two track plugs (28) interconnected by at least two flexible conductor sections (29a) whereby said track plugs make contact with at least one conducting track (14) of one of the respective bordering busbar elements (S).

16. A connecting unit according to claim 15, wherein the female track plug (28) consists of a module link (18) having plug in contact elements (17) with associated contact retainers for the conducting tracks (14) whereby the contact elements (17) on the side of the track plug facing the conducting track of the busbar element are projecting in such a manner past the module link (18) as well as past the contact retainer, which are essentially flush with the frame, so that said contact elements contact the conducting track (14) when the track plug (28) is inserted.

17. A connecting unit according to claim 16, wherein the contact elements (17) with their associated contact retainers are provided in pairs for the functional conductor pairs as a duplex module.

18. A connecting unit according to claim 16, wherein the contact elements (17) for the protective ground conductor together with their associated contact retainers is made as a single module.

19. A connecting unit according to claim 15, wherein fixedly arranged conducting parts are provided parallel to the conducting tracks of the busbar elements in a contacting part facing away from the side of the track plugs (28) on the conducting tracks (14, 14a) of said busbar elements (S) whereby said conducting parts make contact, on the one hand, with the contact elements, and with the flexible conductor sections, on the other hand.

20. A connecting unit according to claim 15, wherein the contact elements (17) are designed as bridges with contacting spring blades (40) molded to both sides of said bridge whereby said spring blades (40) are provided with straight or angled transition pieces which press against the intermediate ribs of the busbar element in the plugged in position of the track plug or whereby said spring blades are designed as insulation displacement contacts.

21. A connecting unit for busbar elements according to claim 1, wherein said connecting unit consists of a plug strip with integrated in line connectors.

22. A connecting unit according to claim 21, wherein contact elements (17) are provided for the conductors in the form of coaxial tube-shaped or hollow-shaped, thin, double sided insulating displacement contacts having axis parallel contact pieces angled toward the inside in form of blades.

23. A connecting unit according to claim 21, wherein contact elements (17) are provided in the form of coaxial tube-shaped or hollow-shaped, thin, double sided, spring loaded clamping connection pieces with contact spring blades oriented toward the inside.

24. A connecting unit for busbar elements according to claim 1, wherein a connecting unit is provided having mounting pieces (49) for the ends of the busbar elements (S) which engage at least in semi circular guide paths (51a) an upper and lower guide disks (51), which are spaced apart, and whereby the flexible conducting sections (29) are guided through the free space between said guide disks (51).

25. A connecting unit according to claim 24, wherein one or several blades (52) can be inserted into the guides of the guide disk (51) in the area of the free space between the mounting pieces (49) and the busbar elements (S).

26. A cover plate for busbar elements according to claim 1, wherein profiled sections are arranged extending on the inner side of the U-shaped profiled section (1) in longitudinal direction to receive butt joint facings.

27. A cover plate according to claim 26, wherein provided tapered sections and/or snap on profiled sections (4) and/or snap on hooks are formed on the lateral edges which engage specially designed longitudinal profiles in the busbar elements (S), under formation of a gap between the cover plate (5, 7) and the busbar elements (S) on at least one longitudinal side.

28. A butt joint facing for cover plates according to claim 26, wherein longitudinal ribs are provided in one profiled section (5a) supported by the U-shaped profiled section (1) or the sub profile sections (22) whereby snap on longitudinal ribs (5b) are provided in the receiving parts of the cover plate.

29. A functional unit for busbar elements according to claim 1, wherein said functional unit has at least one adapter plate for the optionally detachable receiving parts of conventional functional inserts (B), such as, for example, female plugs, switch elements, outgoing cables, sensor elements, indicator or display elements, as well as a track plug (28) and a locking element (19).

30. A functional unit according to claim 29, wherein said functional unit is provided with a track plug (28) designed as described above whereby the flexible conductor sections (29) are connected to the contacts of the functional insert (B).

31. A functional unit according to claim 30, wherein rigid conducting tracks (29) connect the contact elements (17) of the track plug with the contacts of the functional insert (B) in place of flexible conductors.

32. A functional unit according to claim 31, wherein fixedly arranged conductor sections are provided in the track plug (28) on the side facing away from the conducting tracks (14, 14a) of the busbar elements (S) for all electric circuits whereby said conductor sections are oriented parallel to the conducting track of the busbar element and whereby said conductor sections make contact with the contact elements (17) in the selected electric circuit, on the one hand, and whereby said conductor sections are connected to one another through series switching or parallel switching in the way of the conducting track, on the other hand, and whereby the conductor sections are connected to the functional inserts (B) and to the contact elements.

33. A functional unit according to claim 29, wherein at least one boring (32) is provided in the adapter plate and optionally also in the functional insert (F) whereby said boring extends through the adapter plate, optionally through the functional insert, and normally through the bottom or the front side of the retaining profiled section (16) of the busbar element and exactly above said retaining profiled section (16).

34. A functional unit according to claim 29, wherein at least one conducting surface is provided on the adapter plate on the side facing the functional insert (B), whereby said conducting surface is bow-shaped about a center axis and extends at least along a quarter of a circle about this center axis, whereby the rear side of the functional insert facing the adapter plate is provided with at least one respective contact surface per contact surface of the adapter plate.

35. A functional unit according to claim 34, wherein that the front side of the adapter plate is provided with a receiving part for conventional plugs or other functional inserts and part of a guide structure is provided on the side of the adapter plate having contact surfaces, which is preferably a closed circular structure, and whereby the counter piece of the guide structure of the adapter plate is provided on the side of the functional unit facing said adapter plate.

36. A functional unit according to claim 34, wherein a boring leading to the retaining profiled section (16) extends through the adapter plate and the functional unit (B) whose center coincides with the center axis of the contact surfaces and the guide structures.

37. A locking unit to be inserted into the boring of the adapter plate or possibly into the functional insert (B) comprising a retaining structure which cooperates with the retaining profiled section (16) and which can be inserted into said retaining profiled section or encompasses its end section.

38. A locking unit according to claim 37, including two central symmetrically arranged snap on wedges (45) on two parallel spring loaded lugs (46) preventing twisting whereby said snap on wedges engage the lateral strips of the retaining profiled section (16) of the busbar element (S) or encompass the head of the retaining profiled section.

39. A locking unit according to claim 38, wherein said snap on wedges (45) are designed to be at a distance apart from the upper end and the lower end of the lugs (46) which prevent twisting.

40. A locking unit according to claim 37, including a radially widened head (19a) at two opposing sides of its end which can be inserted in the retaining profiled section (16).

41. A locking unit according to claim 37, wherein spreadable side pieces (41) are provided on the end of said locking element which can be inserted into the retaining profiled section (16) whereby said side pieces engage the retaining profiled section (16) in the spread position or whereby they create a friction contact with the side wall of the retaining profiled section (16).

42. A locking unit according to claim 37, wherein the spreadable side pieces (41) of the locking element (19) are elastically biased toward the outside about an axis that is normally oriented along the longitudinal axis of the locking element (19) whereby an actuation element is provided which can be inserted into the end of the retaining profiled section (16) which is movable in its longitudinal direction and whereby said actuation element (42) has lateral extensions (42b) of constant length which engage the side pieces at least partially.

43. A busbar element according to claim 1, wherein the busbar element or a profiled section receiving said element is provided with a guiding profiled section (53) for a cable feeding device.

44. A busbar element according to claim 37, wherein the cable feeding device comprises a slide (54) that can be inserted into the guide profiled section (53) and moved by sliding in longitudinal direction therein having a clamping device (55) for at least one cable whereby said slide is attached or can be attached on a feeder band (56).

45. A busbar element according to claim 38, wherein said feeder band (56) is designed in the form of a toothed belt whereby a powered driving pulley (57) designed complimentary thereto can be brought into contact with the feeder band (56) at least periodically.

46. A busbar element according to claim 39, wherein the driving pulley (57) is fastened to a frame which can be periodically coupled to the profiled section receiving the busbar element or to the frame (58) that can be coupled to the busbar element, whereby the driving pulley (57) can be preferably coupled detachably to an external driving device (59).
